(19) United States
(12) Patent Application Publication
(10) Pub. No.: US 2012/0089639 A1
(43) Pub. Date: Apr. 12, 2012

(54) SYSTEM AND METHOD FOR RETRIEVING LOST BAGGAGE IN TRAVEL INDUSTRY

(76) Inventor: Dapeng Wang, Centreville, VA (US)

(21) Appl. No.: 13/270,214

(22) Filed: Oct. 10, 2011

Related U.S. Application Data
(60) Provisional application No. 61/392,459, filed on Oct. 12, 2010.

(51) Int. Cl. G06F 17/30

(52) U.S. Cl. 707/770; 707/E17.014

(57) ABSTRACT

A system and method for retrieving a lost baggage by its owner is provided. This method provides the baggage owner a system to actively participate in searching the lost baggage using the provided World Wide Web portal site, which is connected to the central database server. This system includes baggage warehouse; baggage inventory terminals; baggage data management software; central database server which will hold the textual information and images on the baggage and its content; a user browsing and searching interface through the said portal site. The baggage owner can actively join the search process for the lost baggage by searching the database, browsing the search results, viewing the baggage images. This system increases the success rate of returning the lost baggage to its owner by utilizing the owner's knowledge on the lost baggage.

### RELATED PATENT APPLICATION

This application claims the benefit of U.S. Provisional Application No. 61/392,459, filed Oct. 12, 2010, which is incorporated herein by reference.

### FIELD OF THE INVENTION

The invention relates to a system and method for retrieving lost baggage in travel industry by disseminating the lost baggage information through a database server and World Wide Web portal site and, more particularly, retrieving the lost baggage by actively utilizing the baggage owner's knowledge on his/her lost baggage. The invention can be further used as a system and method for providing a service to travel carriers, like airlines, on retrieving the lost baggage.

### BACKGROUND OF THE INVENTION

The lost and missing baggage is a big concern for the passengers and the travel carriers, like the airlines. The lost baggage brings loss to the passengers financially and emotionally. The lost baggage is also a big distraction and financial burden to airline operation, beyond the deteriorated customer relations.

During travel, for example the airline travel, a passenger is separated from his/her baggage from departure airport to the arrival airport. Most of the passengers' baggage will arrive at the destination as scheduled. But there is always some baggage being mis-directed or mis-handled. When a passenger realizes that his/her baggage does not arrive at the destination, he/she can file a missing bag claim with the airline baggage agent, with the information about the passenger, and the description of the baggage and its contents. The agent will initiate a search process to locate the mishandled baggage, like searching the computer records. In most cases the baggage is loaded on a different flight and will come at a later time. Currently the airlines have systems in place to handle the mis-handled baggage. The procedure generally involves gathering passenger information, searching the report of the found baggage waiting to be identified. Typically most of the mis-handled baggage will be reunited with its owner in a week or so after the claim is filed. This type of baggage is deemed as delayed baggage.

Sometime a baggage will take longer time to be located for the passenger, and there are cases that baggage is not located at all. These become lost baggage. The reason varies. If a baggage lost its tag during handling, or is misdirected during transit, it will have high probability to become a lost baggage. The probability to locate the baggage decreases as time passes by. Eventually the missing baggage is deemed as lost baggage by the airline after the airline exhausts its effort with no results after certain period of time, which varies by airlines. The existing systems do not have means to directly involve the passengers in the searching process.

After the passenger's baggage is classified as lost, the passenger will have to submit an itemized list of the content inside the baggage for compensation from the airline. Airline agents will work with the passenger to settle on an amount as compensation. Usually the airline thinks the compensation is fair, while the passenger thinks the amount is only the fraction of the real loss, not even mention the emotional value on some of the special items in the baggage. This is additional cost to the airline in terms of the compensation, time spent, and resources used in locating the lost baggage. Lost baggage is loss for both the airlines and passengers.

At the mean time, each airline has accumulated large number of unclaimed baggage from every day operation. Each airline baggage office will handle unclaimed baggage in each airport. After a few days, typically 3˜10 days varying by the airline, the unclaimed baggage be shipped to each airline Baggage Center for future process and storage. The baggage will stay in the Baggage Center waiting to be identified by the baggage agents who are working on the missing baggage claims. After sitting in the Baggage Center for certain period of time, these accumulated lost baggages will be eventually sold in an auction to a third party, like the Unclaimed Baggage Center, or in a store operated by the airline. This resale of the lost baggage brings in revenue for the airline, but it is only a fraction of what the airline has spent on it. This resale on lost baggage also causes frustration to the passengers. This leads to poor customer relations. Travel carriers always want to cut down the number of the lost baggage.

With the help from the technology advancement, airline can have new tracking method on the baggage, like the use of RFID in baggage tracking. Even with this improvement, the lost baggage problem can not be completely eliminated for the travel industry.

On average about 2%˜5% of the missing baggage ends up as lost baggage every year. One main reason for the lost baggage is that the information passed from the passenger to the airline agent is easily mis-communicated and distorted. A passenger is required to describe the baggage and its content in textual format on the missing baggage claim form based on his/her memory. This is a very hard job for the passengers. Normally, passengers will not take pictures on his/her baggage and content before the travel starts. The baggage agent who handles the claim will have to establish a baggage image from the passenger's description. Information is easily lost and distorted during this communication process. Working on a missing baggage claim with the distorted information makes it difficult for the success retrieval of a lost baggage. Today, airlines have adopted a set of codes and keywords for lost baggage description. Still millions of baggage does not reunite with their owners.

For the foregoing, this whole search process is entirely within the travel carrier, like the airline, based on the distorted baggage information, with not much participation from the passenger himself/herself. The passenger's role in this process is only limited as filing a claim at the beginning and contacting the airline for status check during the search. There is a need for actively involve the passengers in the search process. This will improve the success rate on reunite the lost baggage with its owner.

### SUMMARY OF THE INVENTION

The purpose of the present invention is to provide an efficient system and method for identifying the owner of a lost baggage, by actively involving the passengers into this process, before and/or after the airlines exhausted their existing methods of searching.

The present invention provides a system for retrieving a lost baggage, including: one or multiple Lost Baggage Centers (LBC) to store and process the lost baggage; one or multiple baggage inventory stations, which will extract the baggage's textural information and capture visual images on the baggage and its contents; a central database server which will hold the baggage information; a baggage data management software, which will manage the lost baggage database, responding to passenger's request, etc.; and a World Wide Web portal site, with which the passenger will search and browse the images and descriptions on the baggage. The LBC can be a travel carrier or its baggage center/baggage department; or a service provider working with the travel carrier, to process the lost baggage.

Additionally, the present invention provides a system to the passenger, who lost his/her baggage during a travel, to search for the lost baggage in the lost baggage database based on his/her search criteria on the provided World Wide Web portal site. The present invention also provides a system for the said passenger to request more information on a particular baggage in the lost baggage database when there is a near-match. A near-match is a baggage that looks similar to the said passenger's lost baggage but the passenger needs more information to confirm the finding. The present invention further provides a system for the said passenger to claim ownership on a particular baggage in the lost baggage database and ask for verification.

The present invention provides a method for identifying the owner of a lost baggage comprising: extracting the lost baggage information, both textural description and visual images including the baggage images and/or its content images; saving the baggage information in a lost baggage database server; searching and browsing the lost baggage database through a World Wide Web portal site by the passenger.

Additionally, the present invention provides a method for passengers to identify his/her lost baggage from the lost baggage database by refining search criteria, browsing the search results and viewing the baggage images.

Further, the present invention includes a method for requesting more information on a particular baggage if the passenger thinks the baggage is a near-match, and a method for the LBC to fulfill that request.

The present invention also includes a method for the passenger to claim the ownership of a baggage, and a method for the LBC to verify the ownership.

Baggage will be returned to its owner after the ownership is verified.

In accordance with the present invention, a baggage deemed as lost will be handled by the LBC. The LBC agents will inventory the lost baggage on the inventory station, by extracting the baggage description data alone with the baggage images taken by an image capturing device, like a camera. The baggage data including but not limited to identifying data of the baggage such as its brand, color, size, weight, material, airline, content, location, and images on the baggage and its contents, is extracted and saved to the central baggage database. Each baggage is assigned a unique identification number for tracking purpose. The LBC will provide a World Wide Web portal site, which is connected to the lost baggage database. The passenger, who lost his/her baggage during travel, can search the database from the provided World Wide Web portal site anytime after the data is made available. The said passenger will define his/her own search criteria based on his/her knowledge, and browse the baggage images from the search results. If the said passenger finds his/her baggage, he/she can claim ownership and request for verification. If he/she finds a near-match, he/she can request for more information on the particular baggage. The LBC can either verify the ownership claim or provide more baggage information, based on the request type.

Since the baggage images will provide the most accurate baggage visual information, and the baggage owner has the most accurate imagery memory on his/her baggage, this method will certainly improve the success rate on finding the baggage owner. The airline will pay out less in compensation. The system and method in this invention will also cut down cost by reducing the needed resource and work load by utilizing the passenger's effort in searching for the lost baggage.

The present invention can be used by the travel carrier, like an airline, to process the missing or lost baggage. It can also be used as a service provided to the travel carriers by an individual or a company in return for financial or other benefits.

### BRIEF DESCRIPTION OF THE DRAWING

For a more complete understanding of the present invention and for further features and advantages thereof, reference is now made to the following description taken in conjunction with the accompanying drawings, in which:

FIG. 1 is a schematic diagram of the system according to the present invention.

FIG. 2 represents a flow chart of an exemplary inventory procedure for creating new baggage data or editing existing baggage data in LBC.

FIG. 3 represents a flow chart of an exemplary method for search the baggage database by a passenger.

FIG. 4 represents a flow chart of an exemplary method for verify the ownership on a baggage.

### DETAILED DESCRIPTION OF THE INVENTION

In the following detailed description, certain specific terminology will be employed for the sake of clarity and a particular embodiment described in accordance with the requirements of 35 U.S.C. 112, but it is to be understood that the same is not intended to be limiting and should not be so construed inasmuch as the invention is capable of taking many forms and variations within the scope of the appended claims.

According to the concept of the present invention, a lost baggage retrieving system with the active participation from the passengers is utilized.

The lost baggage retrieving system may be operated by Lost Baggage Center (LBC). The LBC can be a travel carrier's Baggage Center/Baggage Department; or a service provider working with the travel carrier, to process the lost baggage.

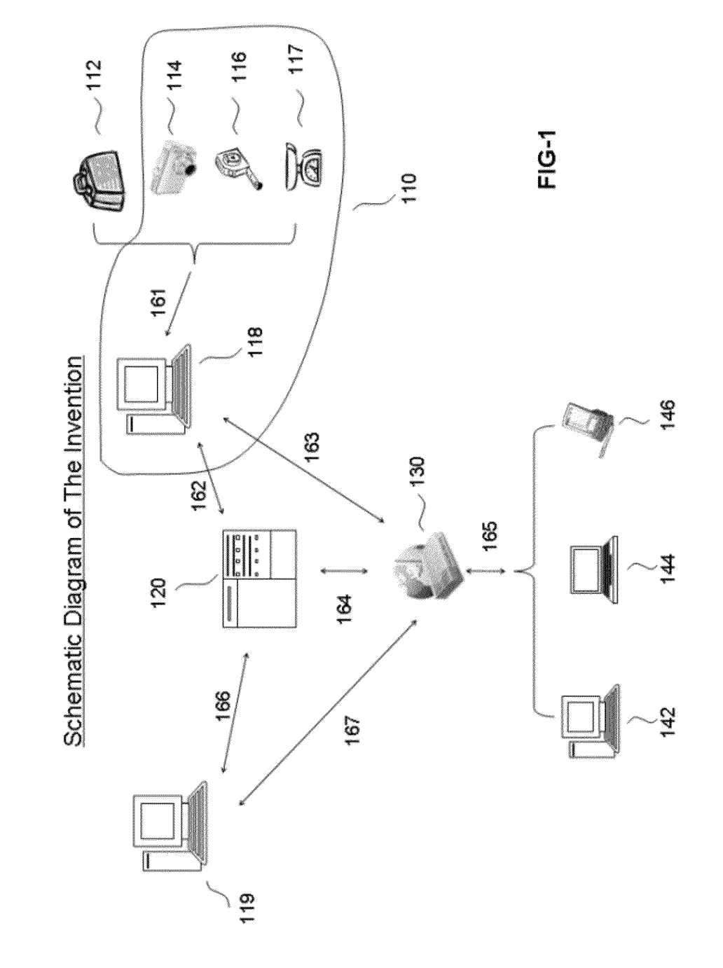

According to the system of the present invention, a lost baggage 112 is examined on the inventory station 110 before it goes into warehouse (FIG. 1). Every piece of baggage can be assigned a unique tracking number. The inventory station 110 has an image capture device 114, like a camera, to take the baggage images and content images; a measurement mean, like a tape measure 116 or a scale 117; and a computer 118 to take the baggage data input through a baggage inventory software. The baggage data can be manually input to computer 118 or through automatic data collection path 161. The baggage data collected will be saved to the baggage database server 120. The connection between the inventory station computer 118 and the database server 120 can be a direct connection 162, or through the World Wide Web 130, via path 163 and 164.

The baggage database server 120 will be the central place to hold the baggage data, and response to the search request from the end users. An end user can be a passenger who lost his/her baggage during travel. The database server 120 is accessible through the World Wide Web 130 by the end users. An end user can access the baggage database server from a provided website via one of the user computer 142, a laptop computer 144, or other mobile computing device 146, through World Wide Web 130, via path 164 and 165. The browser will provide end user with search and browse functions to access baggage data and view the baggage images.

FIG. 1 also includes computer stations 119 for LBC personnel to access or maintain the baggage database, or process the end user request, through the baggage management software. This computer can be connected to the database server through direct connection 166 or via the World Wide Web 130 through path 167 and 164.

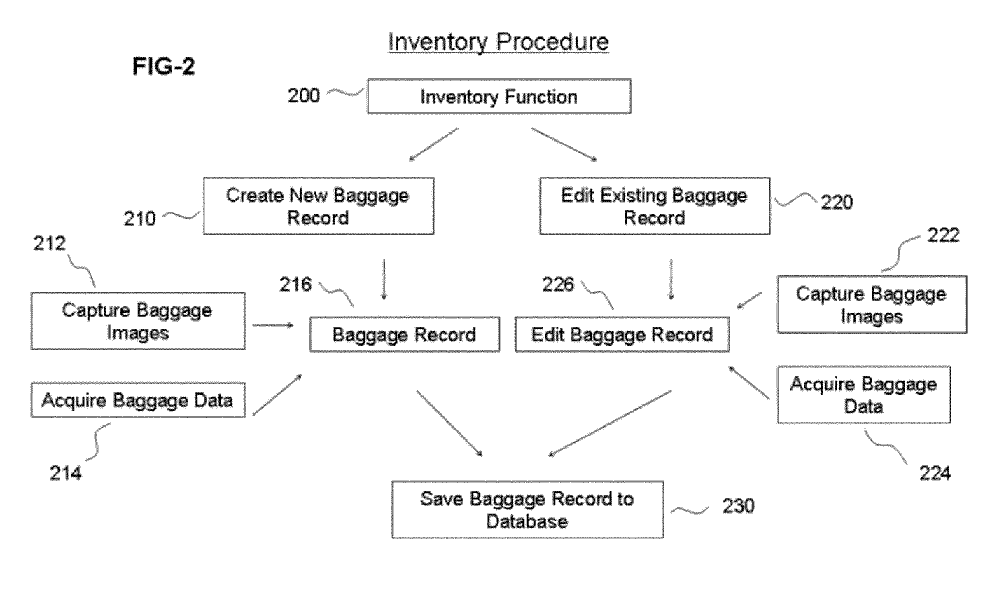

FIG. 2 illustrates a flow chart of the inventory procedure maintained by the LBC. The LBC personnel will choose from the inventory function 200 to create a new baggage record 210 or edit an existing record 220. If a new record is being created, baggage images are taken from step 212, other baggage data can be acquired from step 214. A new baggage record is created in step 216. After the required data is acquired, the baggage record is saved to database at step 230. If the LBC personnel choose to edit existing baggage record from step 220, the extra baggage data is acquired from step 224, and extra baggage images can be acquired from step 222. Finally, the baggage data is edited in step 226. The updated baggage record is saved to the database at step 230.

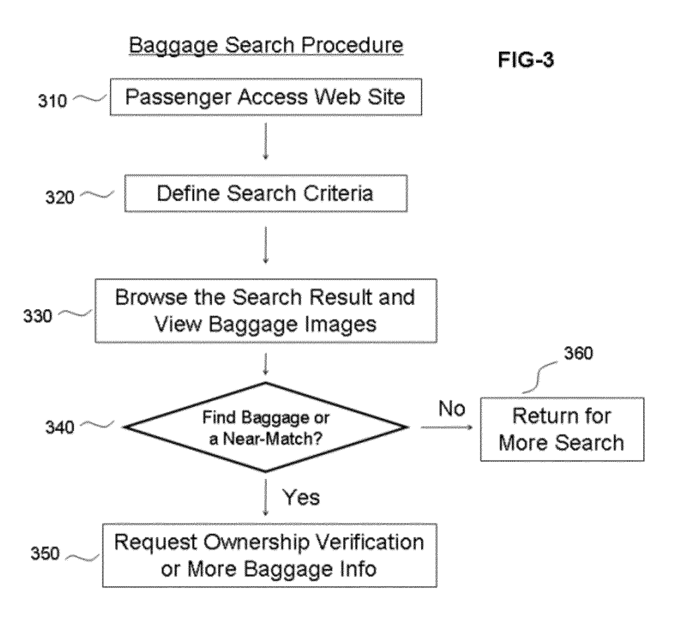

FIG. 3 illustrates a flow chart of the passenger search procedure. The end user, typically a passenger who lost his/her baggage during travel, can access the provided World Wide Web portal site at step 310, via his internet browsing device 142, 144 or 146. At the provided web site, the end user can define his/her own search criteria, at step 320, based on his/her knowledge on the lost baggage. The database server 120 will provide the search results and the baggage images. The end user can browse the search results and view the baggage images at step 330. While browsing the search results, the end user can decide if he/she finds his/her lost baggage or finds a near-match at step 340. The end user can claim to be the owner of that particular baggage and request for ownership verification; or request more baggage information on the near-match for further review at step 350. The request for more baggage information can be fulfilled by Edit Existing Baggage Record operation defined in step 220, 222, 224, 226 and 230 in FIG. 2. If the said end user does not find any baggage that matches his/her lost baggage, he/she can return for more searches at step 360, with re-defined search criteria or at a later time.

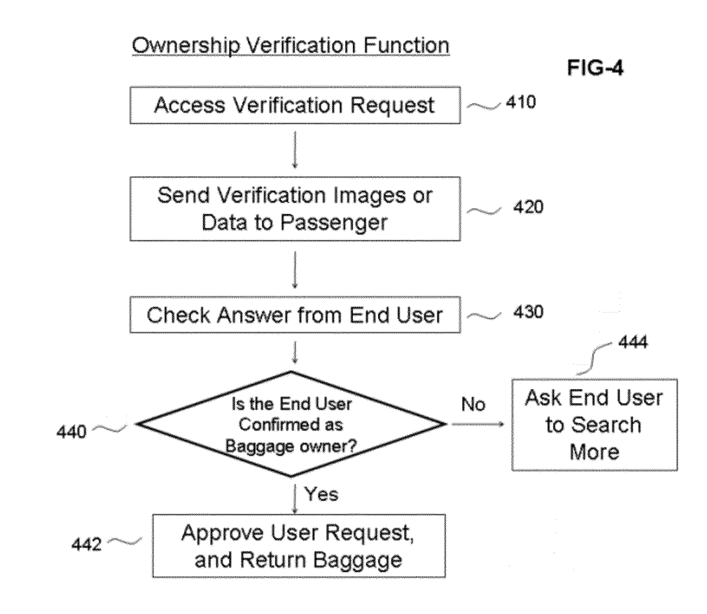

FIG. 4 illustrates a flow chart for the ownership verification function. This function is available for the LBC personnel. Once LBC receives an owner verification request from the end user, the LBC personnel can access verification request, at step 410, via the computer 118 or 119 defined in FIG. 1. The LBC personnel will send a list of verification images or baggage data, some from the claimed baggage and/or some from a different baggage, to the end user for verification at step 420. The end user will identify the baggage data and the images that belong to the claimed baggage. The LBC personnel or the baggage management software can check the answer from the end user at step 430. Based on the answer, the ownership will be granted or denied. If the end user is confirmed as the baggage owner at step 440, the ownership request is granted and the baggage is returned to the said owner at step 442. The return of the baggage can be handled by the travel carrier, or by a parcel shipping company, or by other means. If the ownership verification fails, the ownership request is denied and end user will be asked to search more at step 444.

Although preferred embodiments of the invention have been described in the forgoing detailed description and illustrated in the accompanying drawings, it will be understood that the invention is not limited to the embodiments disclosed, but is capable of numerous rearrangements, modifications and substitutions of parts and elements without departing from the spirit of the invention. Accordingly, the present invention is intended to encompass such rearrangements, modifications and substitutions of parts and elements as fall within the spirit and scope of the appended claims.

What is claimed is:

1. A method for identifying the owner of a lost baggage by actively involving the passengers or end-users in the search process, said method comprising the steps of:
(a) creating or editing a baggage data record on the lost baggage including its textural description and images;
(b) saving the said baggage data record in a lost baggage database;
(c) providing a portal, like a website, for the passengers or end-users to search the said lost baggage database;
(d) searching the lost baggage database by the passengers or end-users;
(e) claiming ownership by the passengers or end-users;
(f) returning baggage to its owner after successful ownership verification.

2. The method of claim 1 where in the step of creating or editing said baggage data record is comprised of the steps of:
(a) capturing images on the lost baggage and its content;
(b) obtaining baggage textural description data including but not limited to identifying data of the baggage such as the brand, color, size, weight, material, airline, content, and location, etc.;
(c) associating said baggage images and textural description data with said baggage data record;
(d) editing the baggage data record by updating the textural and imagery data.

3. The method of claim 1 where in the step of searching said baggage database is comprised of the steps of:
(a) accessing the said lost baggage database by the end-user through provided portal, like web site;
(b) defining the search criteria by the end-user based on his/her knowledge on the lost baggage;
(c) browsing the returned search results based on the search criteria by the passenger or end-user;
(d) viewing the returned baggage images based on the search criteria by the passenger or end-user.

4. The method of claim 1 where in the step of claiming ownership on a baggage is comprised of the steps of:
a) claiming ownership on a baggage by passenger or end user;
b) verifying the passenger or end-user's ownership claim;
c) requesting more information on a near-match by the passenger or end-user;
d) responding to the passenger or end-user's request on a near-match by providing more baggage information.

5. A system for retrieving a lost baggage by passengers or end-users, said system comprising:
(a) an inventory station to take the baggage data, including its textural description and images, on the lost baggage;
(b) a central baggage database server to save the baggage data record;
(c) a portal, like a Web site, for passengers or end-users to search and browse the said baggage database, or submit request, through any computing devices that have access to the said portal;
(d) a baggage management software to manage the lost baggage database, and respond to the end-user's request;
(e) means to return the lost baggage to its verified owner.

6. The system of claim 5 where in said inventory station is comprised of:
(a) an image capture device, like a camera, to take images on the baggage;
(b) measuring means to measure the dimension, weight, and other descriptive data of the baggage;
(c) a computer terminal with baggage inventory software to save new baggage data or edit existing baggage data, including but not limited to identifying data of the baggage such as the brand, color, size, weight, material, airline, content, images and location, etc.

7. The system of claim 5 where in said portal, like a web site, is comprised of:
(a) a code segment for searching the lost baggage database based on end-user's criteria;
(b) a code segment for browsing the search results from the said search;
(c) a code segment for viewing the baggage images from the said search;
(d) a code segment for submitting ownership claim request;
(e) a code segment for requesting more baggage information on a near-match;
(f) a code segment to verify the ownership based on passenger or end-user's reply if a set of questions has been sent to the said passenger or end-user for verification purpose.

8. The system of claim 5 where in said baggage management software is comprised of:
(a) a code segment to manage the lost baggage database through communication network;
(b) a code segment to response to the passenger's ownership claim;
(c) a code segment to send more baggage data to the passenger or end-user on near-match.
